(19) United States
(12) Patent Application Publication
(10) Pub. No.: US 2009/0179990 A1
(43) Pub. Date: Jul. 16, 2009

(54) Stand-alone video camera

(75) Inventors: Yue Zhang, San Jose, CA (US); Wen Hsu, Saratoga, CA (US)

Correspondence Address: Venture Pacific Law, PC, 5201 Great America Parkway, Suite 270, Santa Clara, CA, 95054, US

(73) Assignee: Qpixel Technology International, Inc., Cupertino, CA (US)

(21) Appl. No.: 11/656,339

(22) Filed: Jan. 20, 2007

(51) Int. Cl. H04N 5/225

(52) U.S. Cl. 348/207.1; 348/E05.024

(57) ABSTRACT

The present invention discloses a novel combination for low cost, stand alone video cameras with surveillance features. In the embodiments, the camera body can be manufactured utilizing inexpensive materials such as press molded plastic, the view finder can be a simple through-hole without a lens, simple indicator lights and buttons can be utilized for programming and status functions, and a removable memory card can be used as primary storage. The video camera can operate on one or more batteries or external power. The video camera can be embedded with surveillance functions offering a variety of programming modes for operating as a security camera. By providing only essential features and features that can be manufactured at low cost, the overall cost of the resulting camera can be kept very low.

### FIELD OF INVENTION

The present invention involves a type of video recording camera and, in particular, a low cost, stand-alone video camera with surveillance features.

### BACKGROUND OF INVENTION

Modern video cameras are typically full-feature cameras with many functions built into a typical video camera or camcorder. Such typical video cameras are complex which must be learned and studied before it can be fully utilized and the offered advanced features can be convoluted and difficult to use. More importantly, modern video cameras are expensive. A simple unit can cost hundreds of dollars. Given these characteristics of typical modern video cameras, these video cameras can only be used in certain situations or scenarios.

In another area, security cameras are typically very simply devices connected to a server where the server directs and controls a number of security cameras. Without the server, the security camera itself has very limited use or cannot be used at all. In other words, it cannot stand-alone on its own; it must be connected either wired or wirelessly to a server.

Given the current state in the field of video cameras, it would be desirable to have a video camera that is low in cost and can stand-alone in operation without being connected to a server.

### SUMMARY OF INVENTION

An object of this invention is to provide a low cost, low power, stand-alone video camera.

Another object of this invention is to provide a stand-alone video camera having surveillance features.

Yet another object of this invention is to provide an easily programmable video camera.

Briefly, the present invention discloses a novel combination for low cost, stand alone video cameras with surveillance features. In the embodiments, the camera body can be manufactured utilizing inexpensive materials such as press molded plastic, the view finder can be a simple through-hole without a lens, simple indicator lights and buttons can be utilized for programming and status functions, and a removable memory card can be used as primary storage. The video camera can operate on one or more batteries or external power. The video camera can be embedded with surveillance functions offering a variety of programming modes for operating as a security camera. By providing only essential features and features that can be manufactured at low cost, the overall cost of the resulting camera can be kept very low and can address a special market segment.

An advantage of this invention is that it provides a low cost, stand-alone video camera.

Another advantage of this invention is that it provides a stand-alone video camera having surveillance features.

Yet another advantage of this invention is that it provides an easily programmable video camera.

### DESCRIPTION OF THE DRAWINGS

The following are further descriptions of the embodiments of the invention with references to figures and examples of their applications.

FIG. 1 is a block diagram of the circuitry of a preferred embodiment of the present invention.

FIGS. 2a and 2b are illustrations of certain physical options of the preferred embodiment of the present invention.

FIG. 3a is a top-angled view of an alignment feature for aligning the camera head of the preferred embodiment of the present invention.

FIG. 3b is a front view of an alignment feature for aligning the camera head of the preferred embodiment of the present invention.

FIG. 3c is a side-angled view of an alignment feature for aligning the camera head of the preferred embodiment of the present invention.

FIG. 4 is an illustration of further physical options of the preferred embodiment of the present invention.

### DETAILED DESCRIPTION OF THE EMBODIMENTS

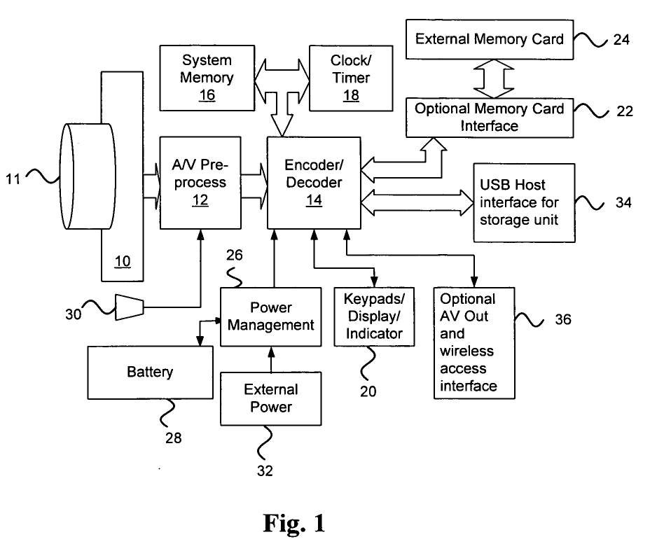

Referring to FIG. 1, a block diagram illustration of a presently preferred circuitry of the present invention is illustrated. Here, there is an optical sensor module 10 with a camera head 11 for video capture. There may be an optional microphone 30 for audio capture. The captured audio and/or video information is preprocessed by a preprocessor 12 and encoded by an encoder 14. Optionally, the encoder can be a codec having both encode and decode functions for encoding and decoding both audio and video information. The encoder can utilize system memory 16 in the preprocessing and encoding of audio and video information. It can also interact with a clock/timer module for controlling the function of the video camera. There is also a memory card interface 22 for accepting removable memory cards 24, where the memory card can be in one of the various formats (e.g. compact flash card, SD card, mini-SD, micro-SD, memory stick, memory stick pro, USB memory sticks, etc.). In the preferred embodiment, an USB interface can be provided such that any USB memory stick or storage devices can be used 34. Such USB interface can be the primary (or only) interface for the primary (or only) storage of images for the preferred embodiment of the video camera of the present invention. Furthermore, the preferred USB interface can be the series A plugs and receptacles. The advantage of utilizing an USB based device is that it simplifies the storage management process. The advantage of utilizing a series A type of USB receptacle is that USB based memory sticks and storage devices are becoming prevalent and well understood in the market place. Further advantage of using a USB based external storage device as the primary or sole storage method is that the overall manufacturing cost of the video camera can be further reduced.

In another embodiment, the system memory 16 can be optional and the external memory card 24 is used as system memory. Furthermore, to certain extent, embedded firmware can be decompressed to external memory (or stored in external memory) in order to minimize the size of firmware required. System memory can be RAM (DDR, mDDR, etc.) and/or ROM (EEPROM, flash ROM, etc. for firmware). Furthermore, the functions of the camera can be programmed and/or controlled by a program stored in external memory. Here, the camera would look for the specific program and be programmed accordingly and function accordingly. Moreover, the firmware can be updated via external memory as well.

Power source to the video camera can be via one or more batteries 28 or an external power source 32, all managed by a power management module 26. The video camera can be programmed via one or more keys or buttons, and the status of the camera can be displayed via a simple LCD or one or more indicator lights. Optional audio and video out and wireless access interface can also be provided 36.

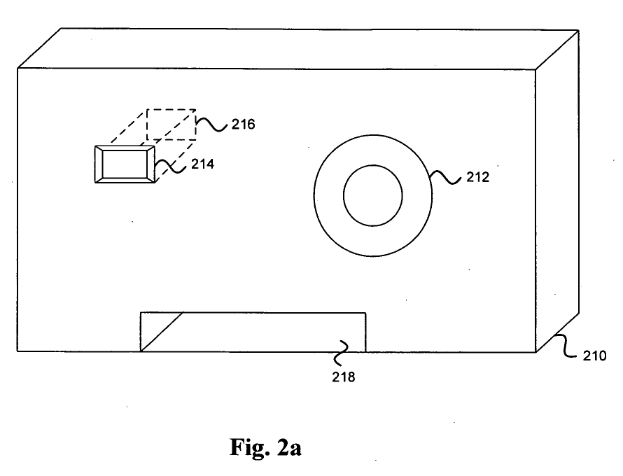

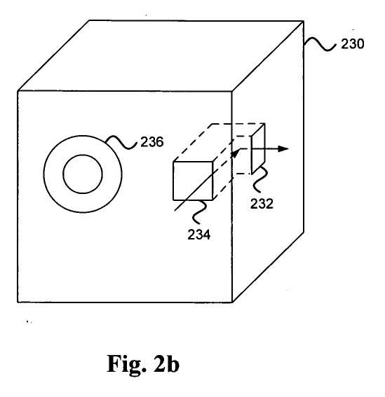

In order to minimize the cost of the preferred embodiment of present invention, a number of novel features are provided. Referring to FIG. 2a, here is an illustration of a potential, simple physical layout of the preferred embodiment. Disposed on the camera body 210 is a camera lens 212, a view finder 214 and a memory card slot 218. The view finder 214 can be a simple through hole with or without lenses. In the preferred embodiment, no lens is used and the view finder is a through hole extending from one side of the camera body to the other side. This feature would reduce manufacturing cost. The memory card slot 218 in this preferred embodiment is disposed at the front side of the camera body. The advantage in having the memory slot at the front side is for ease of access if the camera of the present invention is mounted as a security camera. Given that security cameras are usually mounted at obscure places where access is not always convenient, having a memory card slot at the front of the camera would allow better access to the memory card. Referring to FIG. 2b, in another implementation, the view finder is placed in such a manner that it can be view from the front 234 or from the side 232 of the camera body 230.

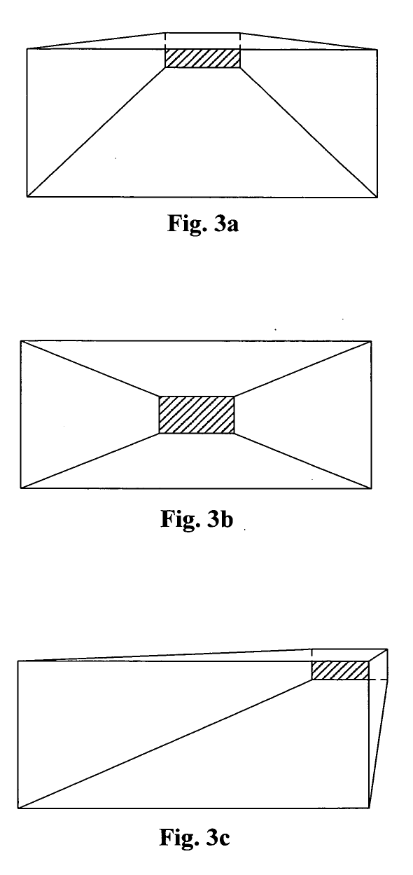

In yet another embodiment in the alignment of the camera, an alignment cone can be implemented in addition to using the view finder. The purpose of the alignment cone is to assist in the alignment of the camera shooting angle, serving as a view finder. In this implementation, the alignment cone would be place in front of the camera body in the shape of a cone or slot in the camera body. At the end of the cone, there is a bright color dot illuminated by paint, led, etc. In using the alignment cone, if a user in front of the camera can see the bright color dot, it would indicate that the user would be in the camera image. If the user cannot see the bright color dot, the user would not be in the camera image. In this manner, the camera can be easily setup and aligned. FIG. 3a illustrates a top-angled view from the user perspective where the color dot (illustrated by the shaded area) can be partially seen, indicating that the user is partially within the camera image. FIG. 3b illustrates a direct front view where the color-dot can be seen totally, indicating that the user is within the camera image. Similarly, FIG. 3b illustrates a side-angled front view where the color dot can be seen partially, indicating that the user is within the camera image on one side. Although these figures illustrate a rectangular embodiment of the alignment cone, the cone itself can be in other shape, such as a circular cone shape.

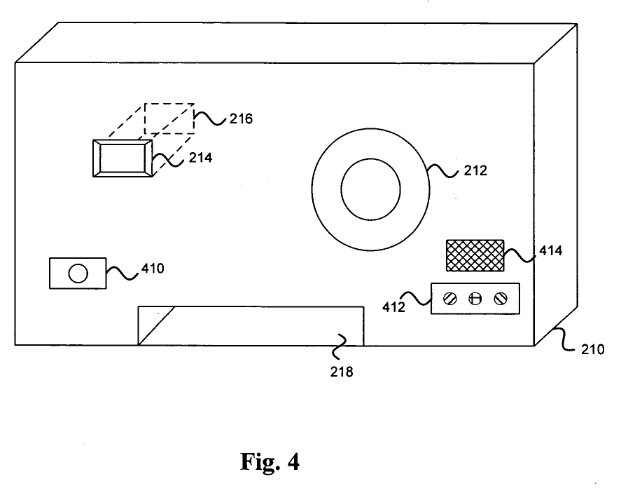

To further maintain low implementation cost, simple, inexpensive features for controlling the camera and monitoring the status of the camera can be utilized. Referring to FIG. 4, a simple indicator light 410 can be used to monitor battery status or a small LCD 414 can be implemented. A simple push-button setup 412 can be utilized to turn on the camera and control the modes of the camera. For example, an image resolution selection can be programmed via the buttons. Furthermore, slider switches can be used as well to select and indicate a certain choice at the same time. The camera can as well offer mechanical adjustment to zoom and focus features as well. For example, a wheel adjustment on the camera for focus or zoom purposes for fixed position adjustments for far (unlimited distance), mid (20 feet or so), and near (5 feet or so).

In the preferred embodiment of the present invention, several operating modes can be embedded in the firmware of the camera in order to provide various features. For example, in a normal mode, the camera can be turned on and recording can start immediately with the push of a button. In a timer mode, the amount of available memory storage is automatically determined, and given that the user programs an on-time and an off-time, the resolution of the image and the duration between image capture can be automatically selected. In an elapse mode, once the user selects the elapse time between image capture, and an on-time and an off-time, the resolution can be automatically determined. In a resolution mode, the user selects the resolution and the elapse time and/or the on-time, off-time can be automatically selected. Other modes can be provided as a function of memory size, resolution, and on-off time.

Given that there is limited amount of memory size, the camera can be programmed to continue to write to the memory replacing the oldest images once the memory is full or to stop recording once the memory is full. As optional features, the camera can be programmed to turn on via a motion sensor, sound sensor, or light sensor. Moreover, an indicator light can be provided to indicate the detection of the motion, light or sound.

While the present invention has been described with reference to certain preferred embodiments, it is to be understood that the present invention is not limited to such specific embodiments. Rather, it is the inventor's contention that the invention be understood and construed in its broadest meaning as reflected by the following claims. Thus, these claims are to be understood as incorporating not only the preferred embodiments described herein but all those other and further alterations and modifications as would be apparent to those of ordinary skilled in the art.

We claim:

1. A video camera, comprising:
a camera head for capturing images;
an encoder for encoding the captured images to generate encoded information; and
a primary memory interface for receiving the encoded information and storing the encoded information, the primary memory interface being an USB interface having a series A type plug.
